(19) United States
(12) Patent Application Publication
(10) Pub. No.: US 2025/0010596 A1
(43) Pub. Date: Jan. 9, 2025

(54) VIRUS-TIGHT MEMBRANE

(71) Applicant: RKW SE, Mannheim (DE)

(72) Inventors: Leonhard Maier, Babensham (DE); Michael SCHERER, Flintsbach am Inn (DE); Manuel PAUKNER, Schonstett (DE)

(73) Assignee: RKW SE, Mannheim (DE)

(21) Appl. No.: 18/711,681

(22) PCT Filed: Oct. 4, 2022
(86) PCT No.: PCT/EP2022/077596

§ 371 Date: May 20, 2024

(30) Foreign Application Priority Data
Nov. 18, 2021 (DE) 10 2021 130 109.2

(51) Int. Cl. B32B 27/12; B32B 5/02; B32B 27/08; B32B 27/20; B32B 27/30; B32B 27/32; B32B 27/36; B32B 37/12; B32B 37/16; B32B 38/00

(52) U.S. Cl. CPC B32B 27/12; B32B 5/022; B32B 27/08; B32B 27/20; B32B 27/308; B32B 27/32; B32B 27/36; B32B 37/12; B32B 37/16; B32B 38/0012; B32B 2038/0028; B32B 2250/40; B32B 2264/104; B32B 2270/00; B32B 2274/00; B32B 2305/28; B32B 2307/718; B32B 2307/724; B32B 2307/728; B32B 2323/046; B32B 2323/10; B32B 2367/00; B32B 2437/00; B32B 2571/00

(57) ABSTRACT

An arrangement with a film, having a barrier against pathogens, wherein the film has at least one monolithic layer (3) containing a hydrophilic polymer resin capable of absorbing and desorbing moisture, and at least two polyolefin layers with fillers, wherein the film is stretched, and the monolithic layer being arranged between the polyolefin layers (4).

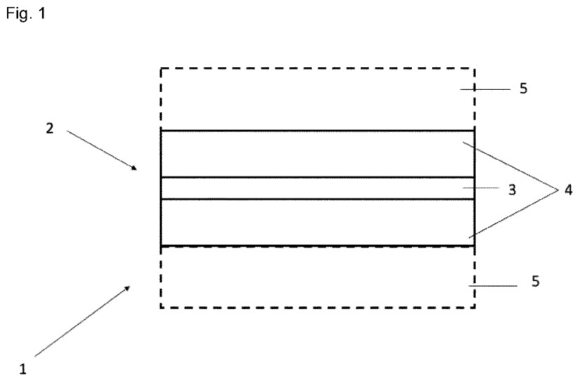

### CROSS REFERENCE TO RELATED APPLICATIONS

This application is a 371 National Phase of PCT/EP2022/077596, filed Oct. 4, 2022, which claims priority from German Patent Application No. 10 2021 130 109.2, filed Nov. 18, 2021, both of which are incorporated herein by reference as if fully set forth.

### TECHNICAL FIELD

The invention relates to an arrangement comprising a film having a barrier against pathogens, wherein the film comprises at least one monolithic layer containing a hydrophilic polymeric resin capable of absorbing and desorbing moisture and at least two polyolefin layers with fillers.

### BACKGROUND

Pathogens are microorganisms or subcellular pathogens that cause harmful processes in other organisms. The term pathogen includes algae, bacteria, parasites, fungi, prions, protists, viruses and viroids. The infection with a pathogen and the subsequent harmful process is referred to as an infection.

To reduce the risk of transmitting pathogens or coming into contact with a pathogen, staff in various patient care facilities wear special protective apparel over their work clothes. As part of basic or standard hygiene, this prevents direct contact with blood, secretions or excretions.

A barrier against pathogens in the form of protective apparel or covers should be airtight to prevent the passage of pathogens on the one hand and transmit water vapor on the other to make it comfortable to wear.

Such features can be ensured, for example, by a monolithic layer made of a polymer resin, in particular a thermoplastic elastomer. These polymer resins create a dense and non-porous layer to prevent the passage of pathogens. At the same time, polymer resins can absorb and desorb moisture, which means that water vapor transmission can be achieved to increase the wearing comfort. Such fabrics are quite cost-intensive and challenging to process. In principle, protective apparel made of pure polymer resin is conceivable, but is extremely uncomfortable for the wearer due to the sticky effect when in direct contact with the skin.

EP 0 848 663 B1 discloses a multilayer, breathable film with at least a five-layer structure. This film is designed as a barrier against microorganisms and as a barrier against blood and body fluids, the film comprising a microporous core layer of a thermoplastic polymer with fillers. The outer layers are designed as monolithic layers of a hydrophilic polymer resin. The layers are each bonded with an adhesive layer. The arrangement of the layers results from the aim of preventing the accumulation of filler on the extruder. The sticky, monolithic layer is unfavorably arranged on the outside of the film, making it difficult to achieve a comfortable feel. The monolithic layer must absorb the moisture to dissipate it, making it unlikely that rapid moisture dissipation can be achieved. Due to today's raw material prices, two monolithic layers are also very expensive.

### SUMMARY

The object of the present invention is to provide an arrangement which has a barrier against pathogens and at the same time makes it comfortable to wear. The arrangement should be transmissive to water vapor and airtight. Furthermore, it should be possible to produce the arrangement as cost-effectively as possible. In addition, the arrangement should not have any sticky surfaces and should not cause any problems during production. Furthermore, the arrangement should meet the relevant standards for protective apparel.

According to the invention, this object is ensured by an arrangement having a film, a method and a use having one or more of the features disclosed herein. Preferred variants can be found in the claims, the description, the embodiment example and the drawing.

According to the invention, the film is stretched, with the monolithic layer being arranged between the polyolefin layers.

The monolithic layer comprises a hydrophilic polymeric resin. Specific examples of suitable hydrophilic polymeric resins include polyesters, polyamides and grades of polyvinyl alcohol and ethyl vinyl alcohol that are substantially water insoluble under the ambient operating temperatures of the stretched film.

In a particularly preferred variant of the invention, the monolithic layer is formed from a thermoplastic copolyester elastomer. Thermoplastic elastomers are plastics that behave similarly to classic elastomers at room temperature, but can be plastically deformed when heat is applied and thus exhibit thermoplastic behavior. These properties enable coextrusion with polyolefin layers.

The monolithic layer made of thermoplastic copolyester elastomer is particularly airtight, even if the layer is particularly thin. As a result, this layer is particularly airtight to prevent the passage of pathogens. At the same time, this elastomer layer is capable of absorbing and desorbing moisture particularly quickly. In combination with the excellent water vapor transmissive, microporous, stretched polyolefin layers, a film can be provided as a barrier against pathogens, which also ensures efficient moisture removal. Protective apparel based on the film according to the invention is therefore particularly comfortable to wear.

On the one hand, the technical process challenge lies in creating sufficient adhesion between the chemically different layers during the coextrusion process. On the other hand, stretching the film to create the water vapor transmission of the polyolefin layers is demanding, whereby the passage of filler particles through the monolithic layer, the accumulation of filler at the extruder nozzles and the detachment of the layers must be avoided.

The challenge is solved in part by the dosed use of an adhesive bonding agent, whereby at least one layer has an adhesive bonding agent. Advantageously, the embedding and insertion of a separate adhesive bonding agent layer is dispensed with, as this would massively impair the water vapor transmission and wearing such protective apparel would be extremely uncomfortable.

In a particularly favorable variant of the invention, an adhesive bonding agent is added to the polymer mixture before extrusion. This can be done, for example, only in the polyolefin layer or only in the monolithic layer. In an alternative variant, the adhesive bonding agent can be added to both component mixtures. In a particularly preferred variant, the adhesive bonding agent is preferably only added to the monolithic layer.

The proportion of adhesive bonding agent is advantageously more than 5% by weight, preferably more than 10% by weight, in particular more than 15% by weight and/or advantageously less than 60% by weight, preferably less than 50% by weight, in particular less than 40% by weight. It has proven to be particularly advantageous to select an exact dosage in order not to unfavorably influence the water vapor transmission of the film.

Preferably, the adhesive bonding agent is a polyolefin-polyamide or polyolefin-polyester adhesive bonding agent, in particular a polyethylene-acrylate copolymer, particularly preferably anhydride-modified ethylene acrylate resin. The adhesive bonding agent comprises a temperature-stable ester, which functionally enables high-temperature coextrusion.

In one variant, the monolithic layer is embedded in the film with the polyolefin layers. The layers do not have to be arranged directly adjacent or connected to each other and can have functional intermediate layers.

In a particularly preferred variant of the invention, the polyolefin layers are directly adjacent or connected to the monolithic layer. The film is thus particularly compact and reduced to the essentials.

In a favorable variant of the invention, the polyolefin layers create the outer sides of the film. Alternatively, further layers can be applied to the polyolefin layer on the side facing away from the monolithic layer.

In a particularly advantageous variant, the proportion of polyolefins in the polyolefin layer is more than 40% by weight, preferably more than 55% by weight, in particular more than 70% by weight.

In a preferred variant of the invention, two different polypropylene (PP) components are used to produce the polyolefin layer of the film. A low-melting PP component is combined with a high-melting polypropylene.

In an extremely advantageous variant of the invention, the polyolefin layer of the film comprises at least 30% by weight of a low-melting polypropylene with a DSC melting point between 135 and 145° C. and at least 8% by weight of a high-melting polypropylene with a DSC melting point between 155 and 165° C.

Calcium carbonate (CaCO₃) and/or calcium oxide (CaO) and/or talc are particularly suitable as fillers for the polyolefin layer. The preferred filler is CaCO₃ in a particle size of 0.8 to 2 μm.

Advantageously, the proportion of filler is more than 30% by weight, preferably more than 40% by weight, in particular more than 50% by weight and/or less than 90% by weight, preferably less than 80% by weight, in particular less than 70% by weight. This allows a polyolefin layer with excellent water vapor transmission rate to be created, so that protective apparel can be made particularly comfortable to wear.

The monolithic layer, on the other hand, is free of fillers, so that this layer is absolutely airtight and therefore tight to the passage of pathogens.

Advantageously, the film is particularly airtight, which ensures an effective and safe barrier against the passage of pathogens.

To make wearing of protective apparel particularly comfortable, the film has a high water vapor transmission rate. The arrangement has a water vapor transmission rate of more than 500 g/m², preferably more than 1000 g/m², in particular more than 1500 g/m² in 24 h according to ASTM D6701-01.

Furthermore, the film is particularly thin with a low basis weight in order to make it possible to wear the protective apparel like a second, low-weight skin. For this purpose, the monolithic layer has a basis weight of more than 1 g/m², preferably more than 1.5 g/m², in particular more than 2 g/m² and/or less than 10 g/m², preferably less than 8 g/m², in particular less than 6 g/m².

Correspondingly, the polyolefin layers are also particularly lightweight. The polyolefin layer has a basis weight of more than 4 g/m², preferably more than 5 g/m², in particular more than 6 g/m² and/or less than 30 g/m², preferably less than 25 g/m², in particular less than 20 g/m².

In order to meet the requirements for protective apparel, the arrangement is designed to be absolutely tight to the passage of pathogens. The arrangement has a resistance according to ASTM F 1671 against the penetration of pathogens. In a favorable embodiment of the invention, the polyolefin layer of the film comprises a low-density polyethylene (LDPE) component. The proportion of this LDPE component is preferably more than 0.5% by weight, preferably more than 1% by weight, in particular more than 2% by weight. The LDPE component is preferably present in a proportion of less than 12% by weight, preferably less than 8% by weight, in particular less than 6% by weight.

To create the microporosity, the films are subjected to a stretching process. According to the invention, at least one stretching process is carried out in the machine direction (MD). In addition, stretching can also take place in the transverse direction (CD). In principle, ring rolling would also be possible. Stretching or stretching the film is understood to mean stretching the film in a specified direction. This leads to a reduction in the film thickness. The film can be stretched in the machine or longitudinal direction (MD direction), for example by a stretching belt comprising one or more rollers. Preferably, the rollers run at different speeds.

Advantageously, the film is particularly thin and lightweight and has excellent water vapor transmission. To this end, the film is stretched by a factor of more than 1:1.5, preferably more than a factor of 1:2 and/or stretched by a factor of less than 1:6, preferably less than a factor of 1:5 in the machine direction (MD).

In a variant of the invention, the arrangement can consist exclusively of the film. In a favorable variant of the invention, the film can preferably be combined with other materials, for example a nonwoven, to form an arrangement. For this purpose, a nonwoven can be arranged on one or both polyolefin layers. Furthermore, depending on the application, it is conceivable that different nonwovens are applied to one polyolefin layer each.

The film can be bonded to a nonwoven, for example with the aid of an adhesive. In one variant of the invention, the adhesive can also be applied over part of the surface.

The arrangement can also be produced using a thermobonding process. In this process, the film and/or the nonwoven can be heated either over a large area or selectively using two heated rollers. For example, an embossing roller with a smooth roller, preferably a steel roller as a counter roller, can be used. High temperature and pressure can melt the film and/or the nonwoven. This bonds the film to the nonwoven.

In addition, the arrangement can also be produced using thermal lamination. In addition or alternatively, the arrangement can also be produced using ultrasonic lamination, for example using Herrmann ultrasonic technology.

Preferably, connecting regions are arranged between the layer of nonwoven fabric and a polyolefin layer, whereby the connecting regions are designed as a form-fitting bond of nonwoven and solidified material of the polyolefin layer.

The terms “nonwoven fabric” or “nonwoven” refer to a fabric that can be produced from continuous filaments and/or discontinuous fibers without weaving or knitting by processes such as s spunbonding, carding or meltblowing or hydroentanglement. The nonwoven may comprise one or more layers of nonwoven, each layer containing continuous filaments or discontinuous fibers. Nonwoven may also include bicomponent fibers, which may have fiber structures such as sheath/core, side-by-side.

According to the invention, the film as a barrier against pathogens is created in a manufacturing process comprising the following steps: The film, consisting of a monolithic layer and two polyolefin layers, is preferably produced by means of blow extrusion, whereby the film is already advantageously pre-stretched. Cast extrusion is also possible.

For this purpose, the mixtures of the different components are prepared for extrusion in a temperature-controlled compound mixer. Preferably, an adhesive bonding agent is added to the components of the monolithic layer, which ensures the formation of the film and its permanent adhesion. Alternatively or additionally, further adhesion promoters can be added to the components of the polyolefin layers. The coextruded film is preferably stretched by a factor of 1:2, particularly in the machine direction.

Ideally, the arrangement or the film is used as protective apparel and as a surgical cover as a barrier against the passage of pathogens, in particular as protection against viruses.

Further advantages and features of the invention are apparent from the description of an embodiment example with reference to drawings and from the drawings themselves.

### BRIEF DESCRIPTION OF THE DRAWING

The only FIGURE shows a section of a five-layer arrangement.

### DETAILED DESCRIPTION

The FIGURE shows a cross-section of a five-layer arrangement 1 comprising a three-layer film 2. The film 2 has a monolithic layer 3 that acts as a barrier against pathogens. In this embodiment, the monolithic layer 3 is designed as a hydrophilic polymer resin, in particular as a monolithic, thermoplastic copolyester elastomer. This elastomer is capable of absorbing and desorbing moisture. As a result, moisture can be transported through this layer, whereby this layer is nevertheless airtight. Advantageously, pathogens can be prevented from passing through this layer. At the same time, however, it is possible to transport moisture caused by perspiration, making protective apparel constructed in this way comfortable to wear. Moisture transport is improved by two polyolefin layers 4, which are arranged around the monolithic layer 3 and have a high water vapor transmission due to their formation with fillers. To make the protective apparel comfortable to wear, layers of nonwoven fabric 5 are arranged on the side of the polyolefin layers 4 facing away from the monolithic layer 3.

In the following, the invention is explained by means of an example, without limiting the invention to this example.

In this example, the following components are used for the polyolefin layer:
57.6% by weight calcium carbonate
32% by weight PP random copolymer
6.4 wt. % PP block copolymer
4.0% by weight LDPE

The filler used is an inorganic filler in the form of calcium carbonate, preferably with a particle size of 0.8 to 2 μm.

The PP random copolymer has a melt flow index of 1.7 g/10 min (at 230° C./2.16 kg) according to ASTM D1238 and a DSC melting point of 142° C.

The melt flow index of the PP block copolymer is 3.0 g/10 min (at 230° C., 2.16 kg) according to ISO 1133.

The LDPE has a density of 0.924 g/cm³. The melt flow index is 0.7 g/10 min (at 190° C., 2.16 kg) in accordance with ISO 1133.

The following components are used for the monolithic layer:
80% by weight Arnitel® VT3118, DSM
20% by weight BYNEL® 22E780, DuPont

Arnitel® VT3118 from DSM is a high-performance thermoplastic elastomer based on copolyester. This elastomer has a melt flow index of 4 cm³/10 min (at 230° C./10 kg) according to ISO 1133 and a tensile strength of more than 20 MPA according to ISO 527-1.

BYNEL® resins are anhydride-modified ethylene acrylate resins. The resins contain a temperature-stable ester that functionally enables high-temperature coextrusion. BYNEL® 22E780 has a density of 0.924 g/cm³ and a melt flow index of 2.0 g/10 min (at 190° C./2.16 kg) according to ASTM D1238.

To produce the film according to the invention, the polymer components are heated with the mineral fillers in an extruder, for example a compounding extruder, to a temperature significantly above the melting temperature of the polymer components (for example above 200° C.) and fused together.

This is followed by blow extrusion according to the invention. In the blow extrusion process, a coextruded blown tube is formed. The three-layer tubular film formed can be laid flat on top of one another and slit open at the ends to create two film webs.

An inflation ratio of 1:2.5 is used in the blown film process.

The primary basis weight of the film is 32 g/m². In the subsequent monoaxial stretching process, the film is stretched by a total of 100% in the machine direction. This results in a film basis weight of 16 g/m².

The film has a water vapor transmission rate of 1200 g/m² according to ASTM D6701-01 in 24 hours.

1. An arrangement (1) comprising:
a film (2) that forms a barrier against pathogens, the film (2) including
a monolithic layer (3) containing a hydrophilic polymer resin capable of absorbing and desorbing moisture, and
two polyolefin layers (4) with fillers,
the monolithic layer (3) being arranged between the polyolefin layers (4).

2. The arrangement according to claim 1, wherein the polyolefin layers (4) are directly adjacent to the monolithic layer (3).

3. The arrangement according to claim 1, wherein the polyolefin layers (4) form outer sides of the film (2).

4. The arrangement according to claim 1, wherein a proportion of the filler of the polyolefin layers (4) is more than 30% by weight and less than 90% by weight.

5. The arrangement according to claim 1, wherein the arrangement (1) has a water vapor transmission rate of more than 500 g/m² in 24 h according to ASTM D6701-01.

6. The arrangement according to claim 1, wherein the monolithic layer (3) has a basis weight of more than 1 g/m² and less than 10 g/m².

7. The arrangement according to claim 1, wherein at least one of the polyolefin layers (4) has a basis weight of more than 4 g/m² and less than 30 g/m².

8. The arrangement according to claim 1, wherein at least one of the layers (3, 4) has an adhesive bonding agent, the adhesive bonding agent being a polyolefin-polyamide or polyolefin-polyester adhesive bonding agent or a polyethylene-acrylate copolymer, a proportion of adhesive bonding agent advantageously being more than 5% by weight and less than 60% by weight.

9. The arrangement according to claim 1, wherein the arrangement (1) has a resistance according to ASTM F 1671 against penetration of pathogens.

10. The arrangement according to claim 1, wherein the film (2) is stretched by more than a factor of 1:1.5, and is stretched by less than a factor of 1:6.

11. The arrangement according to claim 1, wherein the arrangement (1) comprises at least one layer (5) of a nonwoven.

12. The arrangement according to claim 1, wherein connecting regions are arranged between the layer (5) of nonwoven and one of the polyolefin layers (4), the connecting regions being designed as a form-fitting bond of the layer (5) of nonwoven and solidified material of the polyolefin layer (4).

13. A process of manufacturing a film (2), the process comprising:
creating a barrier against pathogens, comprising the following steps:
producing a mixture
extruding the mixture into a film (2),
stretching of the film (2)
wherein an adhesive bonding agent is added to at least one layer (3, 4).

14. The process of claim 13, further comprising incorporating the arrangement (1) into a viral barrier protective apparel or a viral barrier surgical cover.
